(19) United States
(12) Patent Application Publication
(10) Pub. No.: US 2007/0297578 A1
(43) Pub. Date: Dec. 27, 2007

(54) Hybrid recording of communications

(75) Inventors: Christopher D. Blair, South Chailey (GB); Richard L. Heap, Chiswick (GB); Dan Spohrer, Alpharetta, GA (US)

Correspondence Address: THOMAS, KAYDEN, HORSTEMEYER & RISLEY, LLP, 600 GALLERIA PARKWAY, STE 1500, ATLANTA, GA, 30339, US

(73) Assignee: Witness Systems, Inc.

(21) Appl. No.: 11/475,683

(22) Filed: Jun. 27, 2006

(51) Int. Cl. H04M 1/64

(52) U.S. Cl. 379/67.1

(57) ABSTRACT

Systems and methods for recording communications are provided. In this regard, a representative system incorporates recording resources and a recording controller. The recording resources are operative to record information corresponding to communications, with the communications being provided in multiple communication formats and/or involving devices and paths with varying characteristics and capabilities. The recording controller is communicatively coupled to each of the recording resources. The recording controller is operative to: monitor the communications; determine suitability and availability of the recording resources for recording the communications; analyze a recording hierarchy; and allocate at least an available one of the recording resources for recording a designated one of the communications based on the suitability and availability determined and the recording hierarchy.

### BACKGROUND

Recording of communications is important to many industries, particularly those in which compliance regulations have been implemented. Voice recording of telephone communications was originally achieved by high impedance taps on analog (600 ohm) telephone lines. Later, digital (E1, T1, etc.) trunks were tapped to record multiple channels. As phonesets migrated to digital connections to their private automatic branch exchanges (PABXs), recorders capable of tapping these circuits also were developed.

Other recording resources, particularly those designed to sample a small percentage of calls across a large number of users, made use of conferencing or more specialized “agent observe”/“silent observe” features of the telephone switch to route audio from the call to a recorder port. More recently, IP telephony (VoIP) has been recorded by passively tapping IP packets from an Ethernet segment.

Since different customers use different configurations of telephone systems, for a given customer, there is often a choice to be made among several available recording methods for recording the audio communication arriving in the various communications formats. Unfortunately, each recording method typically has corresponding disadvantages.

### SUMMARY

Systems and methods for recording communications are provided. In this regard, an exemplary embodiment of such a method comprises: monitoring communications; determining availability of recording resources for recording the communications; analyzing a recording hierarchy designating which types of recording resources have precedence over others; and allocating an available one of the recording resources for recording a designated one of the communications based on the availability determined and the recording hierarchy.

An exemplary embodiment of a system comprises recording resources and a recording controller. The recording resources are operative to record information corresponding to communications. The recording controller is communicatively coupled to each of the recording resources and is operative to: monitor the communications; determine availability of the recording resources for recording the communications; analyze a recording hierarchy designating which of the recording resources have precedence over others of the recording resources; and allocate an available one of the recording resources for recording a designated one of the communications based on the availability determined and the recording hierarchy.

Computer-readable media also are provided. In this regard, an exemplary embodiment of a computer-readable medium includes a computer program that comprises computer-executable instructions for performing the computer-implemented steps of: monitoring communications provided to a contact center, the communications being provided in multiple communication formats; determining availability of recording resources for recording the communications; analyzing a recording hierarchy defining a recording priority based on types of recording resources for recording the communications; selecting an available one of the recording resources for recording a designated one of the communications based on the availability determined and the recording hierarchy; and instructing the available one of the recording resources to record the designated one of the communications.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

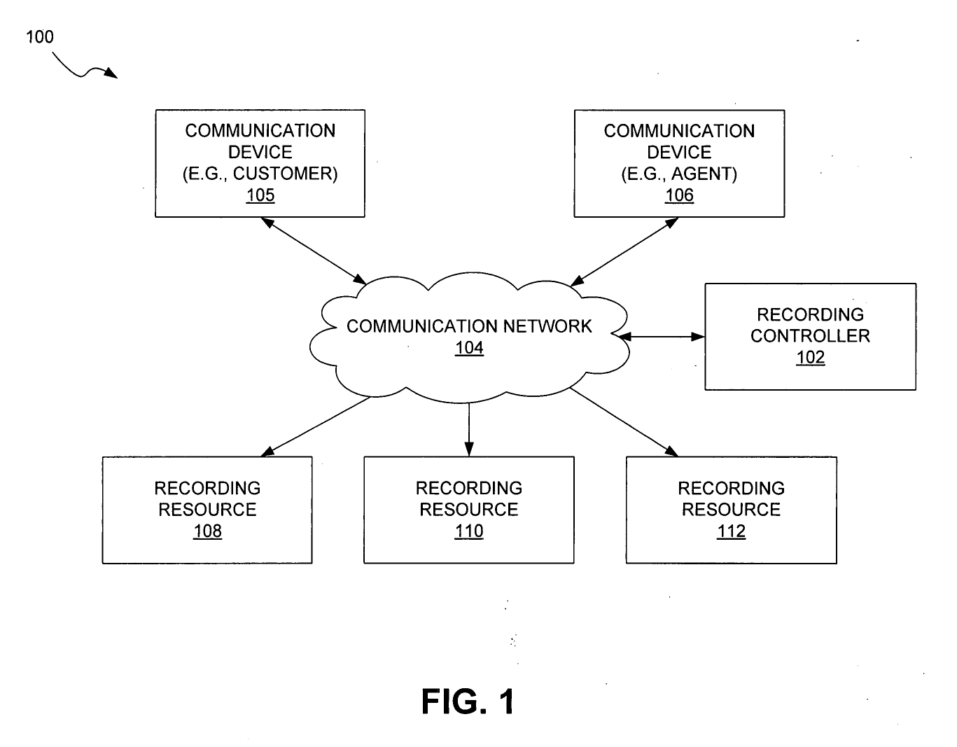

FIG. 1 is a schematic diagram illustrating an exemplary embodiment of a system for recording communications.

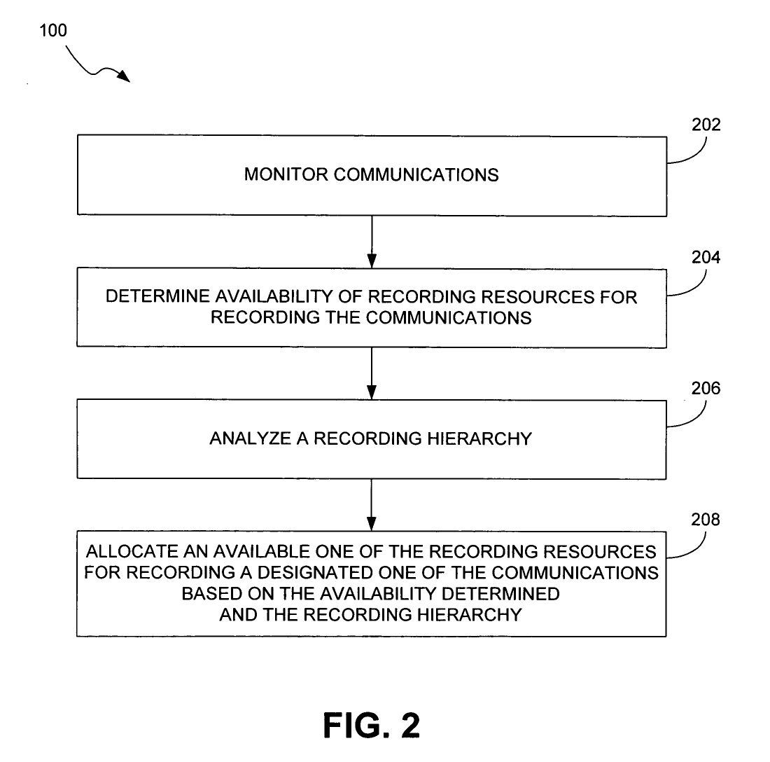

FIG. 2 is a flowchart illustrating functionality (or method steps) that can be performed by the embodiment of the system of FIG. 1.

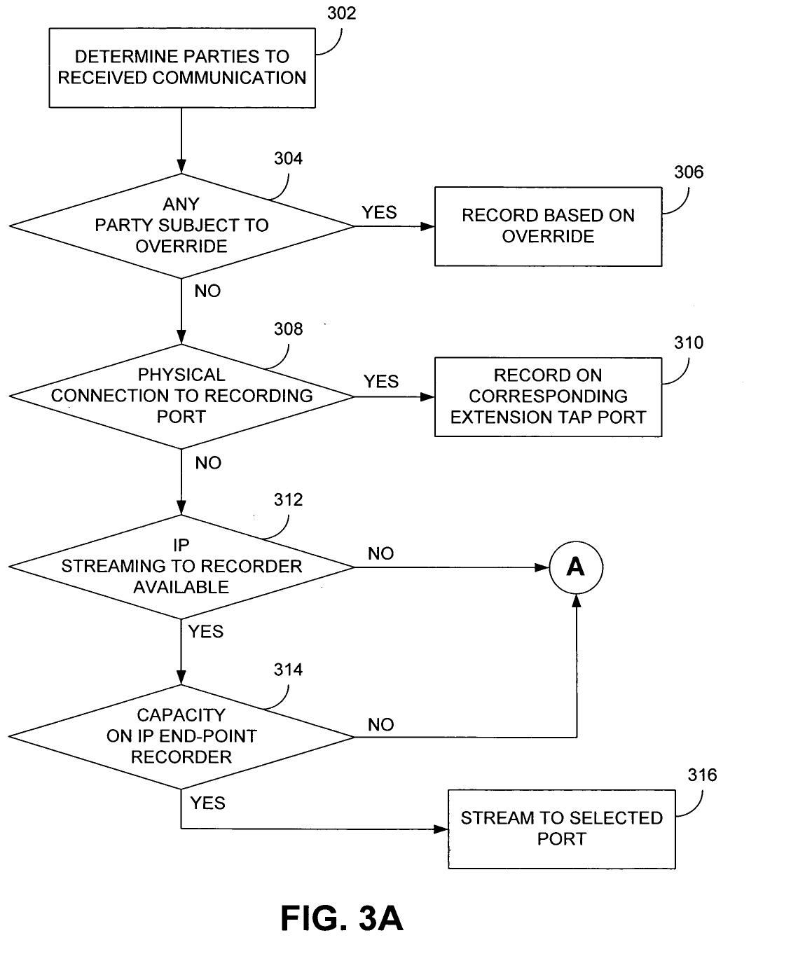

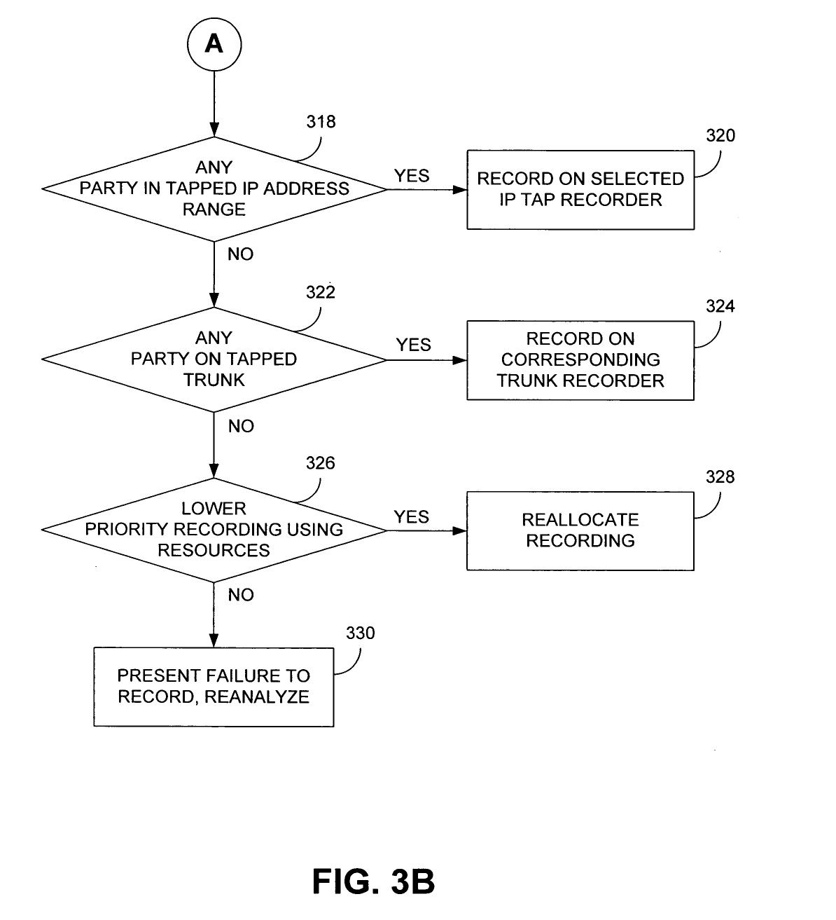

FIGS. 3A and 3B are flowcharts illustrating functionality (or method steps) that can be performed by another embodiment of a system for recording communications.

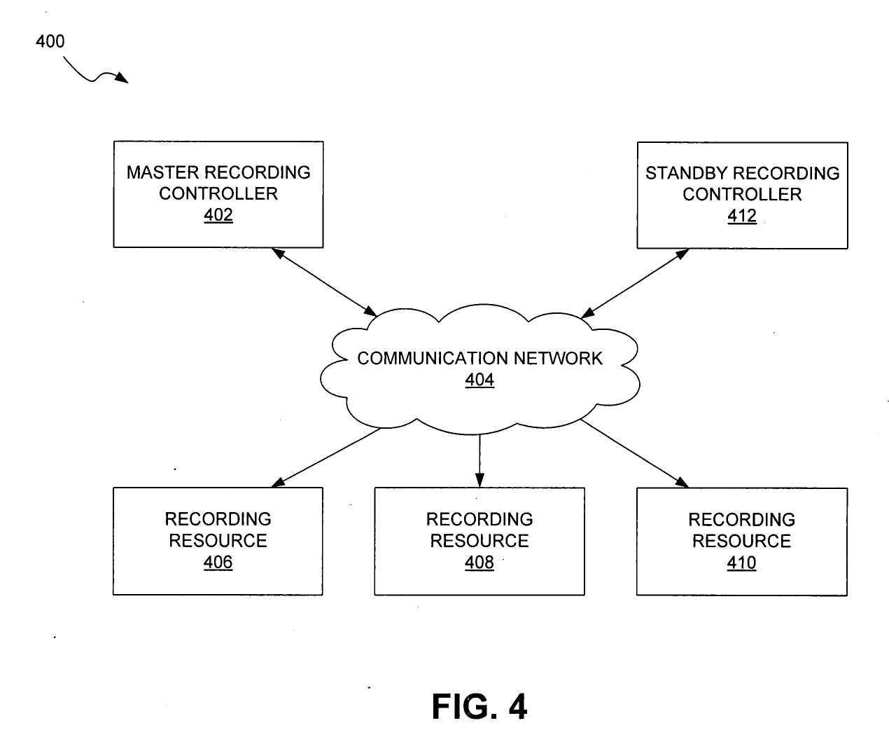

FIG. 4 is a schematic diagram illustrating another exemplary embodiment of a system for recording communications.

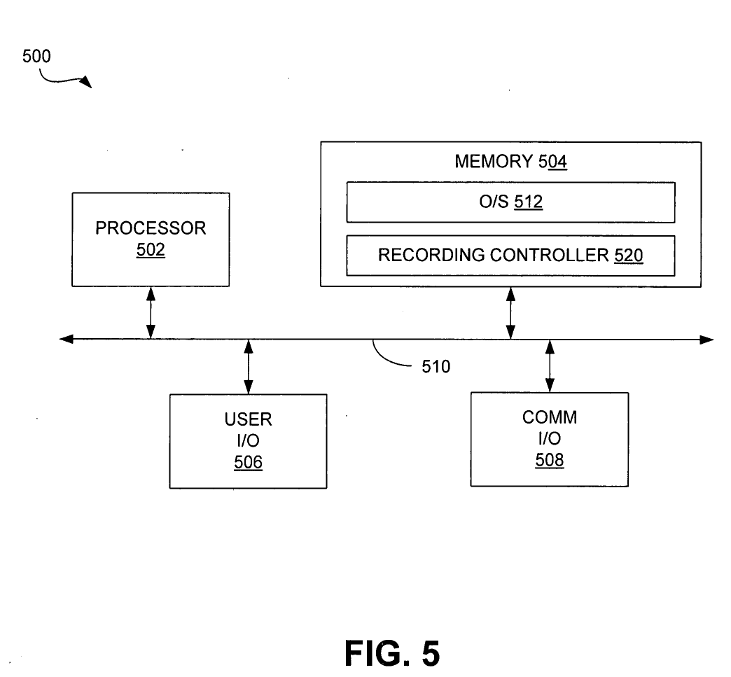

FIG. 5 is a schematic diagram of an exemplary embodiment of a recording controller that can be used in a system for recording communications.

### DETAILED DESCRIPTION

As will be described here with reference to several exemplary embodiments, systems and methods for recording communications are provided. In this regard, embodiments of such a system can incorporate multiple recording resources for recording various types of communications. As used herein, a recording resource can record information of a particular format, e.g., analog telephone or Voice over Internet Protocol (VoIP). Thus, a single recorder that includes provisions for recording both analog telephone and VoIP communications is considered two recording resources.

In some embodiments, a recording controller is configured to receive call control information corresponding to various communications (e.g., telephone calls). The call control information can include information regarding the beginning and ending of a communication, for example, as well as other information such as transfer and hold status. The recording controller monitors the information, which can be provided from one or more of various sources, such as from computer telephone integration (CTI) feeds and analog telephone lines, and directs recording activities of the multiple recording resources. Notably, the recording resources can be disparate types of recording resources, all of which respond to the recording controller for recording the communications. The recording resources also may include those from one or more manufactures/vendors.

Many bulk communications recorders provide APIs through which external control applications may control recording. Using these APIs, a system may use a recorder from another vendor—e.g. a legacy system that can be incorporated into the overall system rather than having to be replaced.

Notably, recording can be based on various parameters, such as the format of the communication that is to be recorded. Additionally, or alternatively, other parameters can be used, such as whether the switch infrastructure allows conferencing into the call—either on TDM or VoIP connection; whether any point through which the call is passing supports media stream duplications or not; and/or whether the IP packets are traversing a segment that is being tapped. In some embodiments, the trunk-side tap may still be used for recording a communication if the call goes out over a traditional trunk.

Referring now in detail to the drawings, FIG. 1 is a schematic diagram illustrating an exemplary embodiment of such a system. As shown in FIG. 1, system 100 incorporates a recording controller 102 that receives call control information corresponding to communications that are provided by a communications network 104. In some embodiments, the communications are between communication devices such as analog telephones although various other types of communication devices, such as digital telephones, conference bridges, and IP telephones, for example, could be used. In this embodiment, communication device 105 is a customer telephone and communication device 106 is an agent telephone. Thus, in this embodiment, the customer call is routed to the agent within a contact center, although various other implementations can be used. Notably, communications network 104 can be any or a combination of network types (e.g., PSTN, WAN, LAN, the Internet) for providing communications of various formats (e.g., analog telephone, VoIP).

In Wide Area Network topologies, the communications may cross multiple physical locations, more than one of which can be recorded. In such a case, it is rare that all recording options would be considered equal. In this regard, a means of defining the preferred location for recording could be used in some embodiments. Such means could include a set of rules for categorizing the call. This will typically determine the likely usage of the recordings and hence can be used to drive recording choice where this is influenced by the path and media used by the call (and hence the recording options available). In such embodiments, the preferred recording method and location can then be chosen with regard to the location of each recording option.

In a further refinement, an element of load balancing, both of storage capacity and of network utilization, can be taken into account in choosing the optimal recorder.

The call control information received by a recording controller can include one or more of various types of information pertaining to a communication. This can include, but is not limited to, the beginning of a communication, the ending of a communication, whether and/or to where a communication has been transferred, hold status, the resource (e.g., telephone) to which the communication has been routed, and an identification of a party to the communication. As will be described later, the recording controller can use the call control information to direct the recording of the communications using the available recording resources.

In this regard, system 100 also incorporates multiple recording resources. Specifically, three recording resources (108, 110 and 112) are provided in the embodiment of FIG. 1. The recording resources receive information for recording from the communication network and record at least a portion of the received information based on instructions provided by the recording controller.

As mentioned before, the recording controller is operative to receive call control information corresponding to communications that are received from the communications network. The recording controller then directs the recording of the communications by the recording resources 108, 110 and 112. For instance, the recording controller can be configured to provide instructions to each of the recording resources to control start/stop/break recording functions of the recording resources with respect to one or more of the communications received.

It should be noted that the embodiment of FIG. 1 provides call control information from the communication network to the recording controller, which then provides recording instructions to the recording resources. In contrast, the recording resources receive communications from the communication network and base recording of those communications on the instructions received from the recording controller. In some embodiments, however, the recording controller could be disposed between the communication network and the recording resources such that the recording instructions and the communications are routed to the recording resources via the recording controller, for example. Additionally or alternatively, the recording controller may receive the call control information indirectly. By way of example, the call control information could be provided to the recording controller by another component, e.g., a component that provides a copy of the information to the recording controller. Thus, it should be noted that systems for recording communications (such as the system 100) could include various components that are not shown in FIG. 1, e.g. servers and switches, with such various components being omitted for ease of description.

It should be noted that, in at least some embodiments, each recorder is a self-contained system that is receiving information about the calls—typically those that it can record—but which passes information on these calls up to the recording controller in order that the recording controller can make the decision and advise the recorder whether or not to record the call. In such a system, each recorder could also operate in “fallback” mode—making its own decisions about what to record in the event that such a recorder cannot communicate with the recording controller.

Additionally, it should be noted that in some embodiments, such as those involving contact centers, information other than that directly related to a communication can be recorded. By way of example, an agent handling a communication may facilitate interaction with a customer (e.g., a caller) by using various computer applications. Information pertaining to the agent's use of such applications could also be recorded. For instance, screens could be captured and recorded. In some of these embodiments, the captured information could be recorded in a manner that allows a reconstruction of the interaction that includes the captured screens being correlated with the captured audio from the communication. This could be accomplished by tagging the captured screens, for example.

As mentioned above, recording resources such as 108, 110 and 112 can be of various types. By way of example, a recording resource can be generally classified as either a passive resource, which does not involve re-routing of a communication to facilitate recording, and active resources that do involve such re-routing (such as within a switch) and media duplication, which involves a copy of the data being created and sent to the recorder In this regard, use of passive resources typically is preferred since use of such resources typically can be less expensive than those requiring re-routing, i.e., additional switching components need not be purchased. Additionally, passive resources typically are only capable of recording specific types of communications because these resources are usually hard-wired to a particular transmission medium. Thus, if installed, such a passive resource should be used if available so that other resources that can potentially offer increased recording flexibility can be used for recording other communications.

Normally, the above is true. However, since passive tap of IP traffic can be less reliable than active participation, the aforementioned default preferences may be overridden in some embodiments.

With respect to passive recording resources, these recording resources involve:

Analogue Taps—typically connected to “Plain Old Telephones” (POTs). Such an analogue tap can use a high impedance tap across the A/B wire pair of a telephone or, in the case of a 4-wire connection, across both pairs with the audio subsequently being recorded as a “stereo” pair of channels or being mixed via analog or digital means into a single audio stream.

Digital Telephone Set Taps—the majority of telephone sets installed in businesses over the last decade or so have been digitally connected to the PABX. These telephone sets typically use some variant of 2B+D basic rate ISDN-like connection, though each vendor typically has developed its own proprietary standard. Most of these standards have been reverse engineered by third parties and can be recorded by tapping into the wires between the PABX and telephone set;

Digital Trunk Taps—most large telephone switches are connected by digital trunks to the central office. These are typically T1 in the United States and E1 in Europe (or higher bandwidth variants of these where higher volume systems are used). A high impedance digital tap allows a recorder to detect bit patterns on the line and record the call; and

IP Passive Taps—connected to a network segment so the recorder can monitor the audio packets (e.g. non-switched Ethernet hub, SPAN port on Cisco switches, RMON remote monitoring, “Mirror” port), then the recorder can record the audio from the monitored audio packets.

With respect to active recording resources, these recording resources involve:

Telset Simulators—connected to a telephone switch so that the recording system appears as one or more telephone sets on the system. This can be done using a card such as those produced by AI-Logix or Dialogix and may connect to the switch using analog or digital circuits or using software to emulate IP phones. Such a recorder may use one or more “softphones” (such as Avaya's CMAPI). This allows the recorder to do whatever a user with the equivalent phone set could do. If the PABX supports this functionality, this can include “service observe” or “agent observe” features that tap into the calls taken by a specified agent or telephone set and copy the audio to the recorder. This could be accomplished using conference bridging capability within the phone system;

Internal Switch Taps—connected to a switch that provides means of tapping into a call within the switch (e.g. Nortel Call Recording Card);

IP End-Point—some phone systems support commands that let the recorder instruct the phone system to copy audio to the recorder on specified IP ports. Nortel CS1000 is an example of this. In this case the telephones transmit copies of the audio to the recorder. Trading room systems may pipe all or selected audio via RTP or similar protocols—often with each packet containing audio samples from multiple voice paths.

Regardless of the particular types of recording resources used for recording, the recording controller is operative to provide instructions to the recording resources to control start/stop/break recording functions of the recording resources. Thus, communications can be effectively recorded despite the recording resources being in various configurations and/or the associated communications being in various formats.

In this regard, FIG. 2 is a flowchart depicting the functionality provided by an embodiment of a system for recording communications, such as the system 100 of FIG. 1. As shown in FIG. 2, the functionality (or method) may be construed as beginning at block 202, in which communications are monitored. In some embodiments, the communications can be provided in multiple communication formats. In block 204, an availability of recording resources is determined for recording the communications. In block 206, a recording hierarchy is analyzed. By way of example, if a communication is able to be recorded by a passive recording resource, such a hierarchy may prescribe that a passive recording resource be used for recording that communication, if available. Thereafter, such as depicted in block 208, an available one of the recording resources is allocated for recording a designated one of the communications based on the availability determined and the recording hierarchy.

In this regard, recording controllers provide instructions to their associated recording resources based on a recording hierarchy that can be designated by one or more rules. Generally, these rules designate those communications that are to be recorded and what recording resources are to be used for facilitating the recording. By way of example, the rules can designate that all incoming communications are to be recorded, and that passive recording resources are to be utilized, if available, for recording a given communication, otherwise, an active recording resource is to be used.

In some embodiments, the rules are defined in terms of the “addresses” and “phone numbers” used within a PABX. These may include physical station identifiers, hunt groups, Vector Directory Numbers, skill groups, Agent Identifiers, ACD queues and IVR ports, for example.

In general, a phone system routes calls according to a defined numbering plan. Each of the recording resources is configured according to which of these numbers are to be recorded. The numbers associated with a recording resource are known as the recording targets of that recording resource. Notably, the rules may be static (e.g. 100% recording for compliance purposes) or dynamically determined (e.g. by a quality monitoring system trying to record a certain number of calls for each agent). The rules may also be combined with other rules such as “do not record internal calls.”

In some embodiments, a recording controller communicates with each of the recording resources via a TCP/IP socket connection and a control protocol. The control protocol allows the master to instruct the recording resources to start/stop/break recordings and to “tag” each recording with details about the call being recorded. Recordings may be “tagged” by sending information relating to the recording, along with information identifying the specific recording, to the recorder. There this information may be stored alongside the recording itself. Such information may subsequently be inserted into a database of recording details where it supplements the inherent information available to the recorder (such as the start time and duration of the recording, the channel on which the recording was made etc,). Alternatively, such tagging information may be sent directly to a database where it is combined with or linked to the specific recording either explicitly through a unique reference number assigned to the recording or implicitly by use of date/time and channel information.

In some embodiments, the user configures the system such that recording controller can communicate with the recording resources. This can be done, for example, by providing the recording controller with the IP addresses of the recording resources and/or configuring the recording resources with the IP address of the recording controller.

In some embodiments, the user also configures basic information about the recording controller and recording resources as follows:

The following table shows typical information and location but note that one could, for example, configure Vox levels at the recording controller.

| | | Information | |
|---|---|---|---|
| Recorder | Information configured | configured at | Information to |
| Type | at Recording controller | Recorder | Recorder |
| Analog | IP address of recorder | Vox levels | Which ports to |
| | Recorder Port to | Encoding to use | record on |
| | Phoneset mapping | | Call details |
| Digital | IP address of recorder | Encoding to use | Which ports to |
| Phoneset | Recorder Port to | Phoneset type | record on |
| tap | Phoneset mapping | | Call details |
| Digital | IP address of recorder | Encoding to use | Which ports to |
| Trunk tap | Recorder Port to | Trunk type | record on |
| | Trunk mapping | | Call details |
| Telset | IP address of recorder | Encoding to use | Which number |
| simulator | Which extension each | How to establish | to observer with |
| | recorder port is | recording | each port |
| | simulating | | Call details |
| Internal | IP address of recorder | IP address of | Which number |
| Switch | | internal tap(s) | to observer with |
| tap | | Encoding to use | each port |
| | | | Call details |
| IP passive | IP address of recorder | Which NIC | Which RTP |
| tap | Which IP address | cards to use for | source/destination |
| | ranges are tapped | recording | addresses to |
| | | | record |
| | | | Call details |
| IP end- | IP address of recorder | Which recorder | Call details |
| point | | “pool” each is in. | |
| | | Maximum | |
| | | capacity | |

Contiguous ranges can be specified (e.g. Ports 1-120 of Digital Phoneset tap Recorder X are connected to Telephone sets numbered 1001 to 1120) for ease of configuring. Additionally, with respect to trunk connections, a single entry could advise the system that 24 (T1) or 30 (E1) consecutive channels on a recorder are associated with a tap point.

As mentioned before, at least some embodiments of a system for recording communications monitor events, in real-time, such as via one or more CTI feeds. This can enable the systems to determine the telephone calls in progress and the parties involved in these calls. When one of the recording rules is triggered, the system determines how to record the call given the availability of recording resources.

In allocating the recording resources for recording, the recording resources can be allocated dynamically to make best use of the available resources. In this regard, default rules can be established to provide the desired recording behavior. Thus, in many cases, this desired recording behavior could occur automatically without the user having to perform an extensive configuration process. Exceptions to the default rules could be configured manually, for example.

In this regard, FIGS. 3A and 3B are flowcharts illustrating functionality (or method steps) that can be performed by an embodiment of a system for recording communications. Specifically, the flowcharts depict application of exemplary default rules that can be implemented by such a system.

As shown in FIG. 3A, the process may be construed as beginning at block 302, in which the parties to a communication are determined. Based on an identification of the parties, a determination can then be made as to whether any of the identified parties are subject to an override rule, such as depicted in block 304. If it is determined that any of the parties are subject to an override rule, the process may proceed to block 306, in which the override rule is used as a basis for recording the communication. However, if the parties are not subject to an override rule, the process may proceed to block 308.

In block 308, a determination is made as to whether the communication involves a physical connection to a recording port. By way of example, if a recorder port is directly connected to an internal party of the communication, such as would exist with an extension tap, then this port cannot be in use for recording another communication at the same time. Moreover, no additional resources need be used to facilitate the recording. Therefore, in this embodiment, the recorder port is the preferred point at which to record the communication. Thus, if there is a physical connection to a recording port, the process may proceed to block 310, in which recording on the corresponding recording port is facilitated. If, however, there is no physical connection, the process may proceed to block 312.

The above case is a good example in which it might be appropriate to override this default behavior. For example, if the recording can be made via IP and routed to its eventual destination, it may be appropriate to use the (e.g. older, lower quality, less flexible . . . ) digital extension tap recorder only as a fallback in the event that IP recording is not available.

In block 312, a determination is made as to whether IP streaming to a recorder is available. By way of example, a determination can be made regarding the capability of any of the phonesets connected to the communication to stream an IP copy of the communication. If the determination is negative, the process may proceed to “A” (which is a flowpoint that continues on FIG. 3B). However, if the determination is positive, a determination can be made as to whether there is available capacity on an IP end-point recorder (block 314). If there is no available capacity, the process also may proceed to “A.” However, if there is capacity available, an IP copy of the communication can be streamed to the selected port for recording as depicted in block 316. Note that, in some embodiments, if multiple IP end-point recording resources are available within a common pool, the most lightly loaded may be selected.

In some embodiments, the determination regarding IP streaming is made automatically and before a recording command is issued. For example, when registering interest in a particular phoneset on a Nortel CS1000 system, the recording controller is advised of the type of phoneset on which this address is terminated. If this is not an IP phoneset, the recording controller may not consider IP end-point recording as an option. Additionally, if the recording controller cannot determine the type of recording supported in advance, the recording controller may attempt a preferred recording mode so long as failure is detectable very rapidly (e.g., less than 1 second). An example of this is a Nortel CS1000 with an IP phoneset being recorded. Most such sets will support IP streaming to an IP end-point recorder so the recording controller will attempt to instruct the phone to do this. Should a failure code indicating that the phoneset in question does not support this feature, the recording controller will reallocate the recording to another type of recorder. In doing so, the recording controller could note the inability of this phoneset to support IP end-point recording and hence not attempt this type of recording again for subsequent recordings.

Referring now to FIG. 3B, as denoted by flowpoint “A,” if it is determined that IP streaming is not available or if there is inadequate capacity on an IP end-point recorder, the process may proceed to block 318. In block 318, a determination is made as to whether any of the parties of the communication are using an IP address in the address ranges covered by one or more IP passive tap recording resources. If any of the parties are in the address range, the process may proceed to block 320, in which the communication is recorded on the selected IP passive tap recorder. Note that, in some embodiments, if more than one IP passive tap recorder is available, the most lightly loaded may be designated for recording.

If the parties are not in the address range, a determination can be made as to whether any of the parties are on a tapped trunk such as depicted in block 322. In particular, if a digital trunk recorder is connected to the trunk used by an external party of the communication to be recorded then that port cannot be in use for anything else at the same time. Therefore, in this embodiment, this recorder port is the preferred point at which to record the communication and the communication is recorded on the corresponding trunk recorder (block 324).

Alternatively, if a telset simulator or internal switch tap recorder port is available, such could be used to record the communication. As these are very flexible recording points that are capable of recording potentially any communication, in some embodiments, these resources are reserved for cases where no other recording mechanisms can be used.

Proceeding to block 326, such as following a determination that no party is on a tapped trunk, a determination is made as to whether a lower priority recording is utilizing recording resources. That is, if no suitable and available recording resource has been identified for use in recording the current communication, the priority of the communication can be compared to other communications that are being recorded. If a lower priority communication is being recorded, that communication could be pre-empted (e.g., reallocated or “bumped”) such that the current communication could be recorded using the recording resource that was being used for recording the lower priority communication (block 328). In some embodiments, when a lower priority recording has an alternative recording mechanism available, recording could be shifted for that communication to an alternative resource. Additionally or alternatively, if no recordings with lower priority can be transferred to alternate resources, an identified recording of lower priority could be truncated from being recorded in order to make the recording resource available for recording the current communication (block 330).

As mentioned above, a user may desire to override or modify default behavior of a system for recording communications, such as described above with respect to the exemplary embodiment depicted in FIGS. 3A and 3B. In this regard, modifying the default behavior may be accomplished by specifying the following, for example:

That specific addresses should be recorded on specific recording resources or named pools of recording resources. This latter option allows for fault tolerant provision of pools of N+1 recording resources at multiple sites. By way of example, each recorder could be configured with its pool name and the recording controller will balance the recording load across the available recording resources. Should one recording resource in the pool fail, the communications directed to that recording resource can be re-established on the remaining recording resources in the pool. Optionally, a heartbeat mechanism can be implemented to allow rapid detection of a failed recorder or network link.

That specific addresses can or cannot be recorded by specific mechanisms. For example, Nortel supports duplicate media streaming from some of their IP phonesets. However, Nortel first generation IP phone sets do not support duplicate media streaming and a recording controller cannot determine this from the information typically provided over CTI. In such cases, the user can force the recorder not to consider a recording mode—in this case, an IP end-point.

That the rules directing the behavior could be applied based on a priority scheme. For example, a regulatory recording need could take priority over a quality monitoring need. These rules can be applied under overload conditions, for example, such as described above with respect to blocks 326 and 328 of FIG. 3B.

That the overall order of preference of the various recording types is configurable such that the order of the steps in the flow chart depicted in FIGS. 3A and 3B, for example, can be reconfigured to suit a range of scenarios.

In some embodiments, a standby recording controller can be provided to shadow the primary or “master” recording controller. An example of such an embodiment is depicted schematically in FIG. 4.

As shown in FIG. 4, system 400 incorporates a master recording controller 402 that receives information from a communication network 404. Recording resources 406, 408 and 410 are also included, each of which receives communications from the network, as well as instructions from the master recording controller regarding the communications that are to be recorded. Notably, the recording resources can receive the information that is to be recorded in various manners, such as from the various components described above.

Additionally, the embodiment of FIG. 4 incorporates a standby recording controller 412. The standby recording controller also communicates with the communication network and with the recording resources 406, 408 and 410. By exchanging heartbeats and copying configuration information from the master recording controller, the standby recording controller can take over the operation of the system should the master fail, i.e., the standby recording controller can provide recording instructions to the recording resources. Additionally or alternatively, the master recording controller could request that the standby recording controller provide the instructions even if the master recording controller is operational. By way of example, the standby recording controller could take over if the CTI connection between the master recording controller and the PABX failed.

In the embodiment of FIG. 4, each recording resource communicates with both the master recording controller and the standby recording controller. However, in this embodiment, even though only one of the recording controllers provides instructions to the recording resources at any given time, both of the recording controllers are advised of the activity and status of the recording resources.

In some embodiments, at least one of the recording resources of a system for recording communications can be used as a standby recorder. This aspect of fault-tolerant recording can be accomplished in various manners. By way of example, if it is determined that one of the recording resources is not capable of recording, information that would have been directed to that recording resource could be directed for recording by the standby recorder.

As another example, fault-tolerant recording can be accomplished by sending the information that is to be recorded to more than one recording resource for recording. For example, continuing with the embodiment of FIG. 4, recording resource 410 could be designated as a standby recorder. In operation, information that is to be recorded could be sent to recording resource 408, for example, and also to recording resource 410, with the information being sent to the recording resources via distinct and hence fault tolerant network paths. Thus, receipt of the information by at least one of the recording resources typically occurs even if a network component or a recording resource fails. However, to avoid using twice the required storage space, it is desirable, in some cases, not to store all the information on both recording resources. This is especially true when the ultimate storage location uses a fault tolerant system such as a SAN.

As long as one of the recording resources that receives the information manages to write the information to long-term memory, then it may be desirable for the other recording resource not to use its long-term memory for storing a copy. However, due to multiple layers of buffering, it may be difficult to determine whether information has been committed to long-term memory. Additionally, it may be difficult to respond quickly to recorder failures since the network between recording resources may take many seconds to re-route traffic around a failed routing node. In both cases, there is a danger that many seconds of information can be lost. This inadequacy can be potentially alleviated by having both recording resources receive information that is buffered in memory.

In particular, in some embodiments, both a recording resource and a standby recorder are operative to receive data packets (IP packets) and ensure that the information contained in the packets is recorded. For example, the recorder 408 writes the information from buffer memory to long-term memory, e.g., a hard drive, and then discards the information from the buffer. The standby recorder maintains the information in buffer memory until the information is assumed to have been transferred to long-term memory of the recording resource 408. For example, the information can be held in the buffer memory of the standby recorder for at least a set time threshold. This threshold can be set to be greater than the sum of the worst case time that information takes to be saved to the long-term memory using the standard buffered communication streams, and the worst case network transmission time to the recording resources. Thus, responsive to determining that recording resource 408 (or network path to that recorder) has failed, all information back to at least that which the recording resource 408 can safely be assumed to have written to disk is still held in the buffer memory of the standby recorder. The standby recorder writes to disk all information held that would normally have been recorded by the presumed failed recorder. Responsive to determining that the recording resource 408 is not properly recording the information, the standby recorder can indicate an alarm condition to ensure that the problem is addressed as rapidly as possible before another component fails in the now potentially non-fault tolerant fallback system.

Notably, in some embodiments, the standby recorder may act as such to more than one recording resource. Since the recording load imposed on a standby recorder may be less than that on other recording resources, i.e., the standby recorder is only buffering information as long as the other recording resources appear to be operating properly, the standby recorder can process incoming information from more than one recording resource. This provides a more economical fallback methodology. However, when the standby recorder does take over from a presumed failed recording resource, it may then be unable to continue receiving and processing the incoming information that is also being directed to other, still healthy, recording resources. In this case, the standby recorder can communicate with the telephony system components that are sending the information to the standby recorder. For instance, the standby recorder could instruct the telephony system to stop sending the information associated with the operative other recording resources, thereby leaving the standby recorder with the information that is being sent to the presumed failed recording resource. The load on the standby recorder is then comparable to that on the presumed failed recording resource for which it is acting as a backup.

In some alternative embodiments, the standby recorder can be configured to write all information received to long-term memory. However, the standby recorder can be further configured to delete information after it has confirmed that the information also has been committed to long-term memory of one or more recording resources. By way of example, if the information is older than a specified threshold (e.g. 1 hour or 1 day), the information can be deleted from long-term memory of the standby recorder so long as the standby recorder receives status information indicating that at least one of the recording resources designated for recording the information is operating properly. If, however, it is determined that a recording resource is no longer operating properly, the standby recorder can stop deleting information from long-term storage, thus ensuring an overlap period with the recorder that is suspected to have failed.

FIG. 5 is a schematic diagram illustrating an embodiment of a computer-implemented device that is configured to perform the functionality associated with a recording controller. Generally, in terms of hardware architecture, computer 500 includes a processor 502, memory 504, a user interface 506, and one or more input and/or communication (I/O) device interface(s) 508 that are communicatively coupled via a local interface 510. The local interface can include, for example but not limited to, one or more buses or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor 502 may be a hardware device for executing software, particularly software stored in memory 504. In this regard, the processor can be any custom made or commercially available processor, a central processing unit (CPU), an auxiliary processor among several processors associated with the recorder, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard® Company, an 80×86 or Pentium® series microprocessor from Intel® Corporation, a PowerPC® microprocessor from IBM®, a Sparc® microprocessor from Sun Microsystems®, Inc, or a 68xxx series microprocessor from Motorola® Corporation.

The memory 504 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory may incorporate electronic, magnetic, optical, and/or other types of storage media. Note that the memory can have a distributed architecture, where various components are situated remote from one another, but can be accessed by the processor. Additionally, the memory can include an operating system 512, as well as instructions associated with a recording controller 520.

The software in memory may include one or more separate programs, each of which includes an ordered listing of executable instructions for implementing logical functions. In this regard, a nonexhaustive list of examples of suitable commercially available operating systems is as follows: (a) a Windows® operating system available from Microsoft® Corporation; (b) a Netware® operating system available from Novell®, Inc.; (c) a Macintosh® operating system available from Apple® Computer, Inc.; (d) a UNIX operating system, which is available for purchase from many vendors, such as the Hewlett-Packard® Company, Sun Microsystems®, Inc., and AT&T® Corporation; (e) a LINUX operating system, which is freeware that is readily available on the Internet 100; (f) a run time Vxworks® operating system from WindRiver® Systems, Inc.; or (g) an appliance-based operating system, such as that implemented in handheld computers or personal data assistants (PDAs) (e.g., PalmOS® available from Palm® Computing, Inc., and Windows CE® available from Microsoft® Corporation). The operating system can be configured to control the execution of other computer programs and provides scheduling, input-communication control, file and data management, memory management, and communication control and/or related services.

It should be noted that a system component embodied as software may also be construed as a source program, executable program (object code), script, or any other entity comprising a set of instructions to be performed. When constructed as a source program, the program is translated via a compiler, assembler, interpreter, or the like, which may or may not be included within the memory, so as to operate properly in connection with the operating system.

When the computer 500 is in operation, the processor is configured to execute software stored within the memory, to communicate data to and from the memory, and to generally control operations of the recorder pursuant to the software. Software in memory, in whole or in part, is read by the processor, perhaps buffered, and is then executed. In this regard, when executing instructions associated with the recording controller, the exemplary functionality described above with respect to recording controllers may be performed.

It should be noted that any of the executable instructions, such as those depicted functionally in the accompanying flowcharts, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non-exhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of embodiments of this disclosure can include embodying the functionality described in logic embodied in hardware or software-configured media.

It should be noted that the flowcharts included herein show the architecture, functionality and/or operation of implementations that may be configured using software. In this regard, each block can be interpreted to represent a module, segment, or portion of code, which comprises one or more executable instructions for implementing the specified logical function(s). It should also be noted that in some alternative implementations, the functions noted in the blocks may occur out of the order depicted. For example, two blocks shown in succession may in fact be executed substantially concurrently or the blocks may sometimes be executed in the reverse order, depending upon the functionality involved.

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. By way of example, although tracking of endpoints of communications have been discussed above in detail, if a CTI allows determination of any intermediate routing points, these could additionally or alternatively be considered as possible streaming or tap points. All such modifications and variations are intended to be included herein within the scope of this disclosure.

Therefore, at least the following is claimed:

1. A method for recording communications comprising:
monitoring communications;
determining availability of recording resources for recording the communications;
analyzing a recording hierarchy designating which types of recording resources have precedence over others of the recording resources; and
allocating an available one of the recording resources for recording a designated one of the communications based on the availability determined and the recording hierarchy.

2. The method of claim 1, wherein the communications are provided in multiple communication formats.

3. The method of claim 1, wherein at least some of the recording resources exhibit diverse recording capabilities with respect to others of the recording resources.

4. The method of claim 1, wherein determining availability comprises determining ability of the recording resources to record the communications.

5. The method of claim 4, wherein determining ability comprises:
attempting to record the designated one of the communications; and
determining whether the designated one of the communications was recorded during the attempting step.

6. The method of claim 1, further comprising:
recording the designated one of the communications using the available one of the recording resources.

7. The method of claim 6, further comprising:
additionally recording the designated one of the communications using another of the recording resources such that fault tolerant recording is provided.

8. The method of claim 1, further comprising:
if more communications are designated to be recorded than there are recording resources available for recording, preempting recording of at least one of the communications designated for recording.

9. The method of claim 1, wherein the recording hierarchy indicates that passive recording resources have precedence over active recording resources such that, if a passive recording resource is available for recording a communication, the passive recording resource is used.

10. The method of claim 1, wherein, in allocating an available one of the recording resources for recording, if multiple recording resources are determined to be available, a recording resource of the multiple recording resources with the lowest recording load is allocated for recording the communication.

11. The method of claim 1, wherein monitoring communications comprises receiving call control information corresponding to the communications.

12. A computer-readable medium having a computer program stored thereon, the computer program comprising computer-executable instructions for performing the computer-implemented steps of:
monitoring communications provided to a contact center, the communications being provided in multiple communication formats;
determining availability of recording resources for recording the communications;
analyzing a recording hierarchy defining a recording priority based on types of recording resources for recording the communications;
selecting an available one of the recording resources for recording a designated one of the communications based on the availability determined and the recording hierarchy; and
instructing the available one of the recording resources to record the designated one of the communications.

13. The computer-readable medium of claim 11, wherein the computer program further comprises computer-executable instructions for performing the computer-implemented step of preempting recording of at least one of the designated communications if more communications are designated to be recorded than there are recording resources available for recording.

14. The computer-readable medium of claim 12, wherein the computer program further comprises computer-executable instructions for performing the computer-implemented step of enabling the recording hierarchy to be modified by a user.

15. The computer-readable medium of claim 12, wherein allocating an available one of the recording resources for recording comprises allocating a recording resource with a lowest recording load that is available.

16. The computer-readable medium of claim 12, wherein instructing the available one of the recording resources to record comprises transmitting instructions to the allocated recording resource in the form of Internet Protocol (IP) packets.

17. A system for recording communications comprising:
recording resources operative to record information corresponding to communications; and
a recording controller communicatively coupled to each of the recording resources, the recording controller being operative to:
monitor the communications; determine availability of the recording resources for recording the communications; analyze a recording hierarchy designating which of the recording resources have precedence over others of the recording resources; and allocate an available one of the recording resources for recording a designated one of the communications based on the availability determined and the recording hierarchy.

18. The system of claim 17, wherein the recording controller is further operative to preempt recording of at least one of the designated communications if more communications are designated to be recorded than there are recording resources available for recording.

19. The system of claim 17, wherein the recording hierarchy indicates that passive ones of the recording resources have precedence for recording the communications over active ones of the recording resources.

20. The system of claim 17, further comprising a standby recording controller operative to determine whether the recording controller is directing recording of the communications by the recording resources such that, if it is determined that the recording controller is not directing recording of the communications, the standby recording controller directs the recording resources to record the communications.

21. The system of claim 20, wherein, in determining whether the recording controller is directing recording of the communications, the standby recording controller is operative to receive information, provided by the recording controller, indicating that the recording controller is operating properly.

22. The system of claim 20, further comprising:
means for determining whether the recording controller is directing recording of the communications by the recording resources.

23. The system of claim 17, wherein the recording controller is operative to monitor the communications via a computer telephony interface (CTI) feed.

24. The system of claim 17, wherein the recording controller communicates with the recording resources using Internet Protocol (IP) packets.

25. The system of claim 17, wherein the recording hierarchy indicates that recording precedence is based, at least partially, on an identification of parties to a communication.
